(19) United States
(12) Patent Application Publication
(10) Pub. No.: US 2015/0206091 A1
(43) Pub. Date: Jul. 23, 2015

(54) SYSTEM, COMPUTER-ACCESSIBLE MEDIUM AND METHOD FOR PROVIDING WORKER DISTRIBUTION PLAN ON BASIS OF PRIORITY

(71) Applicant: P&W Solutions Co., Ltd., Tokyo (JP)

(72) Inventor: Toshiyuki Omiya, Tokyo (JP)

(73) Assignee: P&W Solutions Co., Ltd.

(21) Appl. No.: 14/607,901

(22) Filed: Jan. 28, 2015

Related U.S. Application Data
(63) Continuation of application No. 12/375,817, filed on Nov. 30, 2009, now abandoned.

(30) Foreign Application Priority Data
Jul. 31, 2006 (JP) 2006-208959

(51) Int. Cl. G06Q 10/06

(52) U.S. Cl. CPC G06Q 10/063112

(57) ABSTRACT

A method for making a worker distribution plan on the basis of the priority, a computer, and a program are provided. A computer (10) makes skill level data the top priority and selects workers to be assigned to each work for each predetermined period in descending order of the skill level data according to necessary worker data indicating the number of workers having a necessary skill for each work and for each predetermined period calculated from the predicted value of workload for each predetermined period and priority data indicating the priority for each set of attribute item data and used for selecting workers to be assigned to the work.

### CROSS-REFERENCE TO RELATED APPLICATION(S)

This application is a national stage application of PCT Application No. PCT/JP2007/064982 which was filed on Jul. 31, 2007 and published on Feb. 7, 2008 as International Publication No. WO 2008/016046 (the “International Application”). This application claims priority from the International Application pursuant to 35 U.S.C. §365, and from Japanese Patent Application No. 2006-208959 filed on Jul. 31, 2006, under 35 U.S.C. §119. The disclosures of the above-referenced applications are incorporated herein by reference in their entities.

### FIELD OF THE INVENTION

Exemplary embodiments of the present invention relate to system, computer-accessible medium and method for providing a worker distribution plan on a basis of priority.

### BACKGROUND INFORMATION

In a business center, called a “call center” or a “contact center”, assignment plans (e.g., scheduling) of workers called “operators” or “communicators” in charge of tasks of responding to inquiries from clients by telephone or e-mail, or of carrying out solicitations for products or services or for reminders of receivables, can be an important task which may influence productivity of this type of the business center.

Conventionally, in such business center, a manager carrying out an assignment plan (e.g., scheduling) of workers may create an assignment plan for individual task units (e.g., campaigns) based on work efficiency perceived as a worker's past average handle time (AHT) or qualitative skill level information. For example, a method of automatically creating an assignment plan of workers based on such various conditions as AHT and the like has been described. Certain publications have been provided which may be related to such methods, including, e.g., Japanese Unexamined Patent Application Publication No. 2003-157343.

However, the method of automatically creating an assignment plan of workers by the technology described in the above-referenced publication, while being based on such various conditions as AHT and the like, may not adequately meet needs of an assignment plan for each client in relation to such various attribute information as skill level or work efficiency of workers.

For example, an issue may exist that it may not be possible to generate and/or provide a worker assignment plan appropriately reflecting a priority concerning attribute information for the worker assignment plan.

Thus, there may be a need to address, improve and/or overcome at least some of the deficiencies described herein above.

### SUMMARY OF EXEMPLARY EMBODIMENTS OF THE INVENTION

Therefore, one of the objects of the exemplary embodiments of the present invention can be to provide system, computer-accessible medium and method for carrying out an assignment plan for each worker based on a priority relating to attribute information of workers.

To that end, a first exemplary embodiment of a system, computer-accessible medium and method according to the present invention can be provided, which can be used for a computer—to select a worker to be assigned for each task, with the computer storing certain information in a storage unit/arrangement. Such exemplary information can include an exemplary table of skill attributive items of workers, including a worker identification (ID) identifying a worker, a skill ID identifying a skill of the worker, and data of attribute items associated with the worker ID and the skill ID. Further, the information can include a table of priority data including data of attribute items and data of priority. The data of attribute items can be configured to include data of skill levels representing a degree of proficiency of the skill. In addition, the information can include the priority data represents a priority of each of the data of attribute items for the purpose of selecting a worker to be assigned to the task.

Using the first exemplary embodiment of the system, computer-accessible medium and method according to the present invention, it is possible (e.g., using a computer or a processing arrangement) to assign a highest order to the priority of the data of skill levels; and select a worker to be assigned for each of the tasks and the prescribed periods, based on data of required workers representing a number of workers having a required skill for each of the tasks and the prescribed periods, and the priority data, in order of descending values of the data of skill levels. For example, the data of required workers can be determined or calculated from predicted values of workload for each prescribed period.

By including an exemplary configuration of the first exemplary embodiment of the method, the computer can store or record (in the storage unit or arrangement) the above-described particular information, such as, e.g., the table of skill attributive items of workers, including the worker ID identifying the worker, the skill ID identifying the skills of the worker, and the data of attribute items associated with the worker ID and the skill ID. The information can include the table of priority data including at least the data of attribute items and the data of priority. For example, the data of attribute items can be configured to include the data of skill levels representing a degree of proficiency of the skill; and the data of priority can represent a priority for each of the data of attribute items, for the purpose of selecting a worker to be assigned to the task. Further, the exemplary computer can assigns a highest order to the priority of the data of skill levels. Such exemplary computer can have an operational effect of being able to select a worker to be assigned for each of the tasks and the prescribed periods, based on the data of required workers representing a number of workers having a preferred or required skill for each of the tasks and the prescribed periods, in order of descending values of the data of skill levels. Further, the data of the preferred or required workers can be determined or calculated from predicted values of workload for each prescribed period.

As a result, it is possible for the computer to select a worker to be assigned for each task and prescribed period with priority of the data of skill levels being the highest order in order of descending values of the data of skill levels, based on the data of required workers calculated and the data of priority.

An exemplary result may be that it is possible for the exemplary computer to select a worker based on the data of priority, and there may be a possibility of being able to carry out an assignment plan minimizing excesses and deficiencies of workers and mismatches of skills.

According to a second exemplary embodiment of the system, computer-accessible medium and method according to the present invention, the data of attribute items can further include data of work efficiency determined or calculated based on an average handle time for one task. Further, the exemplary computer can assign a highest order to the priority of the data of work efficiency when assigning a highest order to the priority, for a case in which values of the data of skill levels relating to a plurality of the worker IDs are mutually equal. In addition, the exemplary computer can select the workers in descending order of values of the data of work efficiency during the selection.

By including the exemplary configuration of the second exemplary embodiment to be used with the exemplary embodiment of the system and/or computer-accessible medium according to the present invention, the data of attribute items can further includes data of work efficiency determined or calculated based on an average handle time for one task. Further, the exemplary computer can be configured, programmed and/or structured to assign a highest order to the priority of the data of work efficiency when assigning a highest order to the priority, for a case in which values of the data of skill levels relating to a plurality of the worker ID's are mutually equal. Further, the exemplary computer can be configured, programmed and/or structured to select the workers in descending order of values of the data of work efficiency during the selection.

As a result, in a case in which values of the data of skill levels relating to a plurality of workers are mutually equal, it is possible to assign a highest order to the priority of the data of work efficiency, and to select the workers in descending order of values of the data of work efficiency.

According to a third exemplary embodiment of the system, computer-accessible medium and method according to the present invention, the data of attribute items can further include data of affiliations representing an affiliation of the worker. Further, the exemplary computer can assign a highest order to the priority of the data of affiliation when assigning a highest order to the priority, for a case in which values of the data of skill levels relating to a plurality of the worker ID's are mutually equal, and values of the data of work efficiency relating to a plurality of the worker ID's are mutually equal. The exemplary computer may further select the workers based on a ratio of a number of the workers registered for each of the affiliations during the selection.

By including the exemplary configuration of the third exemplary embodiment to be used with the exemplary embodiment of the system and/or computer-accessible medium according to the present invention, the data of attribute items can further include data of affiliations representing affiliations of the workers. The exemplary computer can be configured, programmed and/or structured to assign a highest order to the priority of the data of affiliations when assigning a highest order to the priority, for a case in which values of the data of skill levels relating to a plurality of the worker ID's are mutually equal, and values of the data of work efficiency relating to a plurality of the worker ID's are mutually equal. The exemplary computer can be further configured, programmed and/or structured to select the workers based on a ratio of a number of the workers registered for each of the affiliations during the selection.

As a result, in a case in which values of the data of skill levels relating to a plurality of workers are mutually equal, and values of the data of work efficiency relating to a plurality of the worker ID's are mutually equal, it is possible to assign a highest order to the priority of the data of affiliations, and select the workers based on a ratio of a number of the workers registered for each of the affiliations.

According to a fourth exemplary embodiment of the system, computer-accessible medium and method according to the present invention, the exemplary computer can select the workers by generating random numbers in the step of selecting, for a case in which values of the data of skill levels relating to the plurality of worker ID's are mutually equal, values of the data of work efficiency relating to the plurality of worker ID's are mutually equal, and values of the data of affiliations relating to the plurality of worker ID's are mutually equal.

By including the exemplary configuration of the fourth exemplary embodiment to be used with the exemplary embodiment of the system and/or computer-accessible medium according to the present invention, the exemplary computer can be configured, programmed and/or structured to select the workers based on generation of a random number during the selection, for a case in which values of the data skill levels relating to the plurality of worker ID's are mutually equal, values of the data of work efficiency relating to the plurality of worker ID's are mutually equal, and values of the data of affiliation relating to the plurality of worker ID's are mutually equal.

As a result, in a case in which values of the skill level data relating to a plurality of worker ID's are mutually equal, values of work efficiency data relating to the plurality of worker ID's are mutually equal, and values of the affiliation data relating to the plurality of worker ID's are mutually equal, it is possible to select workers by generating a random number.

According to a fifth exemplary embodiment of the system, computer-accessible medium and method according to the present invention, the exemplary computer can further be configured, programmed and/or structured to display on a display portion a number of workers for each of the affiliations of workers selected based on a ratio of a number of the workers registered for each of the affiliations, and accept a modifying input of the number of workers displayed. In addition, during the selection procedure, based on a ratio of the number of workers for which the modifying input has been accepted, workers assigned for each prescribed period can be re-selected.

By including the exemplary configuration of the fifth exemplary embodiment to be used with the exemplary embodiment of the system and/or computer-accessible medium according to the present invention, the exemplary computer can be configured, programmed and/or structured to display on the display portion a number of workers for each of the affiliations of the selected workers based on a ratio of a number of the workers registered for each of the affiliations, and to accept a modifying input of the displayed number of workers. The exemplary computer can also be configured, programmed and/or structured to re-select workers assigned for each of the prescribed periods in the step of selecting, based on a ratio of the number of workers for which the modifying input has been accepted.

As a result, since it is possible to re-select workers assigned to each affiliation in a prescribed period, it is possible to adjust a number of workers assigned of each affiliation in a prescribed period based on circumstances of a user.

According to a sixth exemplary embodiment of the system, computer-accessible medium and method according to the present invention, the exemplary computer can accept an input for configuring the priority data. As a result, since it is possible for a client to directly input and designate a priority of attribute items for a purpose of an assignment plan for workers, it is possible to reflect requests of clients in a worker assignment plan. Further, it is possible to meet requests for each client, such as considering available hours per week or per month in making assignments, or in giving priority to workers who have not recently been assigned in assigning thereof.

According to a seventh exemplary embodiment of the system, computer-accessible medium and method according to the present invention, the exemplary computer can store in a storage unit, e.g., (i) a table of skill attributive items including at least a worker ID identifying a worker, a skill ID identifying a skill of the worker, and data of attribute items associated with the worker ID and the skill ID, and (ii) a table of priority data including at least data of attribute items and data of priority. For example, the data of attribute items can be configured to include at least data of skill levels representing a degree of proficiency of the skill. Further, the data of priority can represent a priority of each of the data of attribute items for the purpose of selecting a worker to be assigned to the task. In addition, the exemplary computer can be configured, programmed and/or structured to assign a highest order to the priority of the data of skill levels. The exemplary computer can also include an arrangement which is configured, programmed and/or structured to select a worker to be assigned for each of the tasks and the prescribed periods, based on data of required workers representing a number of workers having a required skill for each of the tasks and the prescribed periods, and the priority data, in order of descending values of the data of skill levels, the data of required workers being calculated from predicted values of workload for each prescribed period. Thus, using this exemplary seventh embodiment, it is possible to anticipate a similar effect as with the first aspect.

According to an eighth exemplary embodiment of the system, computer-accessible medium and method according to the present invention, the data of attribute items can further include data of work efficiency calculated based on an average handle time for one task. In addition, an arrangement which is configured, programmed and/or structured to assign a highest order to the priority of the data of work efficiency can be provided, for a case in which values of the data of skill levels relating to a plurality of the worker ID's are mutually equal. Further, an arrangement which is configured, programmed and/or structured to select the worker in order of descending values of the data of work efficiency can be provided. By utilizing the exemplary computer according to the eighth exemplary embodiment, it is possible to anticipate a similar effect as with the second exemplary embodiment.

According to a ninth exemplary embodiment of the system, computer-accessible medium and method according to the present invention, using the exemplary computer as described above with respect to the eighth exemplary embodiment, the data of attribute items can further include data of affiliations representing an affiliation of the worker. Further, an arrangement which is configured, programmed and/or structured to assign a highest order to the priority of the affiliation data can be provided, for a case in which values of the data of skill levels in relation to a plurality of the worker ID's are mutually identical, and values of the data of work efficiency in relation to a plurality of the worker ID's are mutually identical. In addition, an arrangement which is configured, programmed and/or structured to select the worker based on a ratio of the number of workers registered with each of the affiliations can be provided. By utilizing the exemplary computer according to the ninth exemplary embodiment, it is possible to anticipate a similar effect as with the third exemplary embodiment.

According to a tenth exemplary embodiment of the system, computer-accessible medium and method according to the present invention, an arrangement can be provided which is configured, programmed and/or structured to select the workers by generating random numbers for a case in which values of the data of skill levels relating to the plurality of worker ID's are mutually equal, values of the data of work efficiency relating to the plurality of worker ID's are mutually equal, and values of the data of affiliations relating to the plurality of worker ID's are mutually equal. By utilizing the exemplary computer according to the tenth exemplary embodiment, it is possible to anticipate a similar effect as with the fourth exemplary embodiment.

According to an eleventh exemplary embodiment of the system, computer-accessible medium and method according to the present invention, the exemplary computer as described herein with respect to the ninth or tenth exemplary embodiment(s) can further include an arrangement which is configured, programmed and/or structured to display on a display portion a number of workers for each of the affiliations selected based on a ratio of a number of the workers registered with each of the affiliations, and to accept a modifying input of the number of workers displayed. The arrangement can be provided which is configured, programmed and/or structured to re-select workers assigned for each of the prescribed periods based on a ratio of the number of workers for which the modifying input has been accepted. By utilizing the exemplary computer according to the eleventh exemplary embodiment, it is possible to anticipate a similar effect as with the fifth exemplary embodiment.

According to a twelfth exemplary embodiment of the system, computer-accessible medium and method according to the present invention, the exemplary computer as described herein with reference to the seventh to eleventh exemplary embodiment(s) can further include an arrangement which is configured, programmed and/or structured to accept an input for configuring the priority data. By utilizing the exemplary computer of the twelfth exemplary embodiment, it is possible to anticipate a similar effect as with the sixth exemplary embodiment.

According to a thirteenth exemplary embodiment of the system, computer-accessible medium and method according to the present invention, a program that configures, programs and/or causes a computer to select workers to be assigned for each task can be provided, and/or stored in the computer-accessible medium and/or executed by the exemplary computer. For example, the exemplary computer can store in a storage unit, e.g., (i) a table of skill attributive items of workers including at least a worker ID identifying a worker, a skill ID identifying a skill of the worker, and data of attribute items associated with the worker ID and the skill ID, and (ii) a table of priority data including at least data of attribute items and data of priority. The data of attribute items can be configured to include at least data of skill levels representing a degree of proficiency of the skill. The data of priority can represent a priority of each of the data of attribute items for the purpose of selecting a worker to be assigned to the task. For example, the exemplary program can configure or program the computer to execute (i) an assignment of a highest order to the priority of the data of skill levels, and (ii) a selection of a worker to be assigned for each of the tasks and the prescribed periods, based on data of required workers representing a number of workers having a required skill for each of the tasks and the prescribed periods, and the priority data, in order of descending values of the skill level data. For example, the data of the required workers can be determine and/or calculated from predicted values of workload for each prescribed period. By executing the program of the thirteenth exemplary embodiment using the exemplary computer, it is possible to anticipate a similar effect as with the first exemplary embodiment.

According to a fourteenth exemplary embodiment of the system, computer-accessible medium and method according to the present invention, in the exemplary program as described with respect to the thirteenth exemplary embodiment, the data of attribute items can further include data of work efficiency determined and/or calculated based on an average handle time for one task. The exemplary program can configure, program and/or cause the exemplary computer to (i) assign a highest order to the priority of the work efficiency data in the step of assigning highest order to the priority, for a case in which values of the data of skill levels relating to a plurality of the worker ID's are mutually equal, and (ii) select the workers in descending order of values of the data of work efficiency during the selection procedure. By executing the exemplary program according to the fourteenth exemplary embodiment using the exemplary computer, it is possible to anticipate a similar effect as with the second exemplary embodiment.

According to a fifteenth exemplary embodiment of the system, computer-accessible medium and method according to the present invention, in the exemplary program as described with respect to the fourteenth exemplary embodiment, the data of attribute items can further include data of affiliations representing an affiliation of the worker. The exemplary program can configure, program and/or cause the exemplary computer to (i) assign a highest order to the priority of the affiliation data in the step of assigning highest order to the priority, for a case in which values of the data of skill levels relating to a plurality of the worker ID's are mutually equal, and values of the data of work efficiency relating to a plurality of the worker ID's are mutually equal, and (ii) select the workers based on a ratio of the number of workers registered for each of the affiliations during the selection procedure. By executing the exemplary program of the fifteenth exemplary embodiment using the exemplary computer, it is possible to anticipate a similar effect as with the third exemplary embodiment.

According to a sixteenth exemplary embodiment of the system, computer-accessible medium and method according to the present invention, the exemplary program can configure, program and/or cause the exemplary computer to select the workers by generating random numbers during the selection procedure, for a case in which values of the data of skill levels relating to the plurality of worker ID's are mutually equal, values of the data of work efficiency relating to the plurality of worker ID's are mutually equal, and values of the data of affiliations relating to the plurality of worker ID's are mutually equal. By executing the exemplary program of the sixteenth exemplary embodiment using the exemplary computer, it is possible to anticipate a similar effect as with the fourth exemplary embodiment.

According to a seventeenth exemplary embodiment of the system, computer-accessible medium and method according to the present invention, the exemplary program as described in the fifteenth or sixteenth exemplary embodiment(s) can further configure, program and/or cause the exemplary computer to (i) display on a display portion a number of workers for each of the affiliations of workers selected based on a ratio of the number of workers registered for each of the affiliations, and accepting a modifying input of the number of workers displayed, and (ii) during the selection, based on a ratio of the number of workers for which the modifying input has been accepted, re-select workers assigned for each prescribed period. By executing the exemplary program of the seventeenth exemplary embodiment using the computer, it is possible to anticipate a similar effect as with the fifth exemplary embodiment.

According to an eighteenth exemplary embodiment of the system, computer-accessible medium and method according to the present invention, the exemplary program as described herein with respect to the thirteenth to seventeenth exemplary embodiment(s) can further configure, program and/or cause the exemplary computer to accept an input for configuring the priority data. By executing the exemplary program of the eighteenth exemplary embodiment using the exemplary computer, it is possible to anticipate a similar effect as with the sixth exemplary embodiment.

Based on the exemplary embodiments of the present invention, it is possible for the computer to be configured, programmed and/or structured, by deciding upon a priority of attribute items, to select a worker to be assigned for each of the tasks and the prescribed periods, based on the calculated data of required workers, data of priority, and data of attribute items. As a result, such exemplary computer, based on the data of priority, can be configured, programmed and/or structured to select a worker, and there is a possibility of being able to carry out an assignment plan minimizing excesses and deficiencies of workers and mismatches of skills.

These and other objects, features and advantages of the present invention will become apparent upon reading the following detailed description of embodiments of the invention, when taken in conjunction with the appended claims.

### BRIEF DESCRIPTION OF THE DRAWINGS

Further exemplary objects, features and advantages of the invention will become apparent from the following detailed description taken in conjunction with the accompanying figure showing illustrative embodiment(s), result(s) and/or feature(s) of the exemplary embodiment(s) of the present invention, in which:

FIG. 1 is a block diagram illustrating an exemplary configuration of a computer according to an exemplary embodiment of the present invention;

FIG. 2 is a schematic diagram illustrating a communication configuration of a computer system according to an exemplary embodiment of the present invention;

FIG. 3 is a main flow diagram of a method for carrying out worker selection processing which can be performed by the exemplary computer according to an exemplary embodiment of the present invention;

FIG. 4 is a flow diagram illustrating a method for providing priority data configuration processing according to an exemplary embodiment of the present invention which can be performed by the exemplary computer;

FIG. 5 is a diagram illustrating a priority data table according to an exemplary embodiment of the present invention;

FIG. 6 is a flow diagram illustrating a method for providing assigned worker selection processing according to an exemplary embodiment of the present invention which can be performed by the exemplary computer;

FIG. 7 is a diagram illustrating a required worker by task table according to an exemplary embodiment of the present invention;

FIG. 8 is a diagram illustrating a worker skill attribute item table according to an exemplary embodiment of the present invention;

FIG. 9 is a diagram illustrating a scheduling by task table according to an exemplary embodiment of the present invention;

FIG. 10 is a diagram illustrating a worker skill attribute item table according to an exemplary embodiment of the present invention;

FIG. 11 is a diagram illustrating a scheduling by task table according to an exemplary embodiment of the present invention;

FIG. 12 is a diagram illustrating a worker skill attribute item table according to an exemplary embodiment of the present invention;

FIG. 13 is a diagram illustrating a scheduling by task table according to an exemplary embodiment of the present invention;

FIG. 14 is a diagram illustrating a worker skill attribute item table according to an exemplary embodiment of the present invention;

FIG. 15 is a diagram illustrating a scheduling by task table according to an exemplary embodiment of the present invention;

FIG. 16 is a diagram illustrating a schedule by assigned company screen according to an exemplary embodiment of the present invention;

FIG. 17 is a diagram illustrating a schedule by assigned company screen according to an exemplary embodiment of the present invention;

FIG. 18 is a diagram illustrating a schedule by assigned company screen according to an exemplary embodiment of the present invention; and

FIG. 19 is a diagram illustrating a priority designation screen according to an exemplary embodiment of the present invention.

While the certain exemplary embodiments of the present invention will now be described in detail with reference to the figures, it is done so in connection with the illustrative embodiments.

### DETAILED DESCRIPTION OF EXEMPLARY EMBODIMENTS

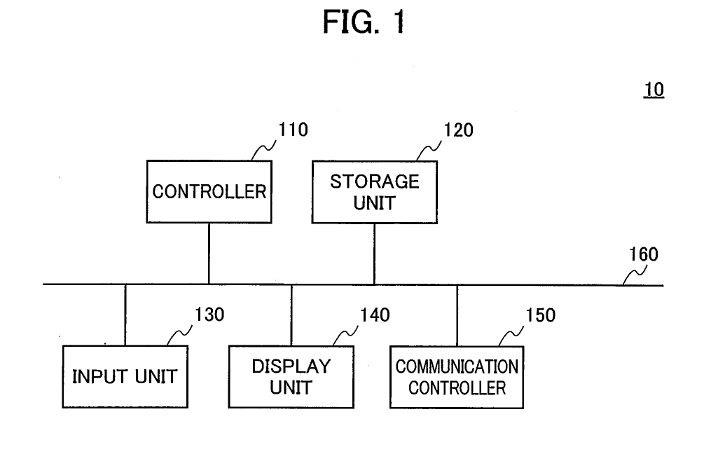

An exemplary embodiment of the system, computer-accessible medium and method according to the present invention is explained below based on the drawings. For example, FIG. 1 shows a block diagram illustrating an exemplary configuration of a computer 10 according to an exemplary embodiment of the present invention. The computer 10 can include a controller 110, a memory unit 120, an input unit 130, a display unit 140, and a communication controller 150 connected together via a bus 160.

The controller 110 can be an information calculation processing device (CPU) performing calculation and processing of information, and providing an overall control of the computer 10. The controller 110, by suitably accessing, reading and executing various programs stored in the memory unit 120 or on another storage arrangement, can function collaboratively with the above-described hardware, and can realize various functions relating to the exemplary embodiments of the present invention.

The memory unit 120 may include a local memory and a high-capacity bulk memory for use in executing a program in combination with the controller 110, and a cache memory for use in carrying out efficient search of the bulk memory. The memory device 120 can be a computer readable or accessible storage medium that may include such memories or storage arrangements as electrical, magnetic, optical and electromagnetic memories, hard drives, etc. For example, semiconductor storage devices, magnetic tapes, Floppy® disks, random access memory (RAM), read-only memory (ROM), memory stick, and optical discs, including CD-ROMs, CD-R/Ws, and DVDs, etc. can be included.

The input unit/arrangement 130 can accept an input by a user, and may include a keyboard, a pointing device, and the like. The input unit/arrangement 130 may be connected to the computer directly or through an intermediate I/O controller. The display unit 140 can be a device to display a screen to a user for accepting input of data, or to display results of calculation processing performed by the exemplary computer on a screen. The display unit/arrangement 140 can include display devices such as a cathode-ray tube (CRT), a liquid-crystal display (LCD), and the like.

The communication controller 150 can include a network adapter for the purpose of enabling the exemplary computer to connect through a special network or public network to another calculation processing system or storage device. The communication controller 150 may include a modem, a cable modem, and/or an Ethernet® adapter.

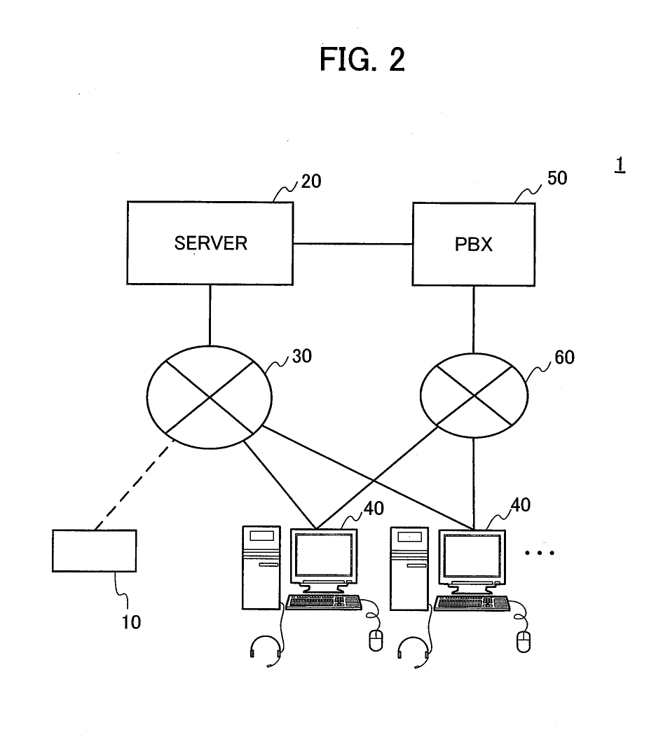

Moreover, the exemplary configurations of the server 20, terminal 40, and PBD 50 to be described herein with reference to FIG. 2 can be similar to those of the exemplary computer 10. Furthermore, the terminal 40 can provide an analog telephone line jack and LAN connector as communication controller 150, possibly facilitating telephone conversation by a headset, mouse, and/or keyboard.

FIG. 2 shows a schematic diagram illustrating an exemplary configuration of a computer system 1 according to an exemplary embodiment of the present invention. In this exemplary system, the computer 10, server 20, and terminal 40 can be configured to be mutually connected through a communication network 30. Furthermore, the server 20 and the PBX 50 may be mutually connected. In addition, the terminal 40 and the PBX 50 can be mutually connected through a telephone line network 60 and/or via another communications network. Further, it may not be necessary for the exemplary computer 10 to be connected through the communication network 30 to the server 20.

The server 20 can store data of past work record per skill possessed by an operator (e.g., hereafter referred to as “worker”), and may perform various processing, such as sending the data of past work record to the computer 10 and the like. Moreover, the server 20 can be a so-called CTI server possibly carrying out routing of inbound calls in tandem with the PBX 50 in a call center or a contact center, or making outbound calls in tandem with an ACD.

According to this exemplary embodiment, an example, a performance of a task using a telephone is explained. However, it should be understood that a technical scope of the exemplary embodiments of the present invention is in no way limited to such exemplary description, and even in a case of using electronic mail to carry out correspondence to clients, it is possible to apply the principle of the exemplary embodiment of the present invention.

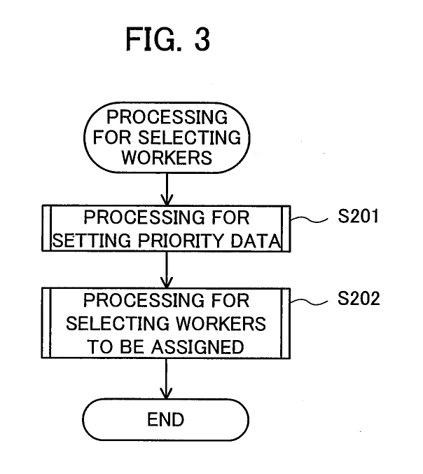

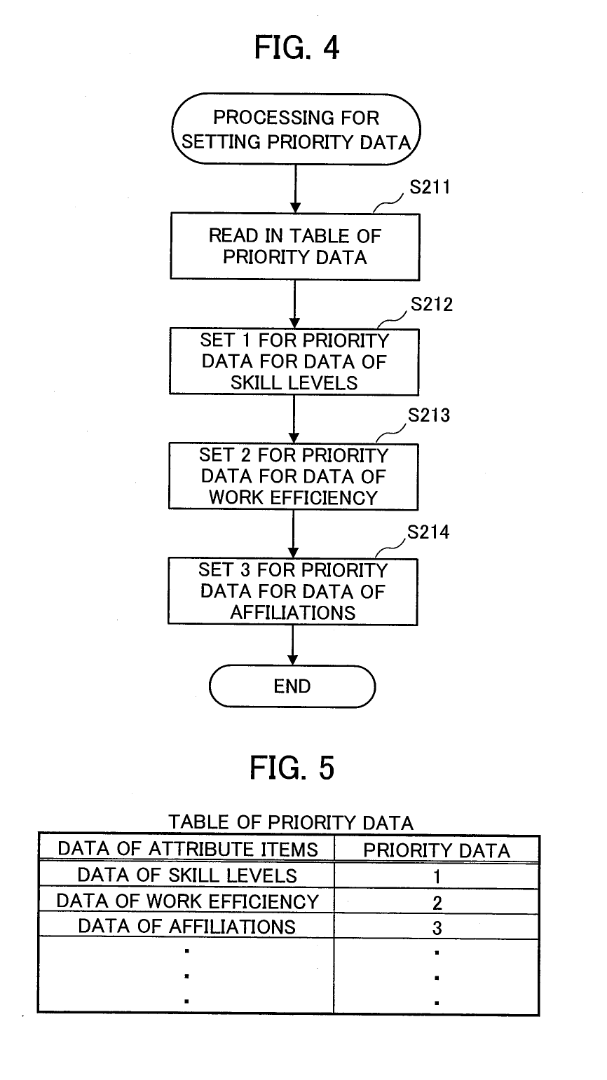

FIG. 3 shows a flow diagram for a method for carrying out processing for selecting workers using the exemplary computer 10 according to an exemplary embodiment of the present invention. For example, the controller 110, in step S201, can perform the processing for setting priority data. Such exemplary processing for setting priority data is illustrated in further detail in the exemplary procedure of FIG. 4. In particular, the controller 110 can read in a table of priority data in Step S211. Further, the computer 10 may store the table of priority data previously in the storage unit/arrangement 120.

An exemplary table of priority data shown in FIG. 5 is a table storing a priority for each of the data of attribute items according to the exemplary embodiment of the present invention. According to a priority for each of the data of attribute items, a worker to be assigned can be selected. For example, in a case in which data of skill levels has priority data of “1”, and data of work efficiency has priority data of “2”, the skill level is prioritized in selecting a worker to be assigned. This exemplary procedure which performs the processing for a selection of a worker to be assigned is described herein.

Further, again referring to FIG. 4, the controller 110, in Step S212, can assign “1” to priority data corresponding to the data of skill levels. Next, the controller 110, in Step S213, can assign “2” to priority data corresponding to the data of work efficiency. Further, the controller 110, in Step S214, can assign “3” to priority data corresponding to data of affiliations, and may terminate the processing for setting priority data.

When the processing for setting priority data completes, as illustrated in FIG. 5, a state is illustrated in which “1” as priority data corresponding to the data of skill levels, “2” as priority data corresponding to the data of work efficiency, and “3” as priority data corresponding to the data of affiliations, each can be assigned. Referring to the flow diagram of FIG. 3, the controller 110 performs the processing for selecting workers to be assigned in Step S202.

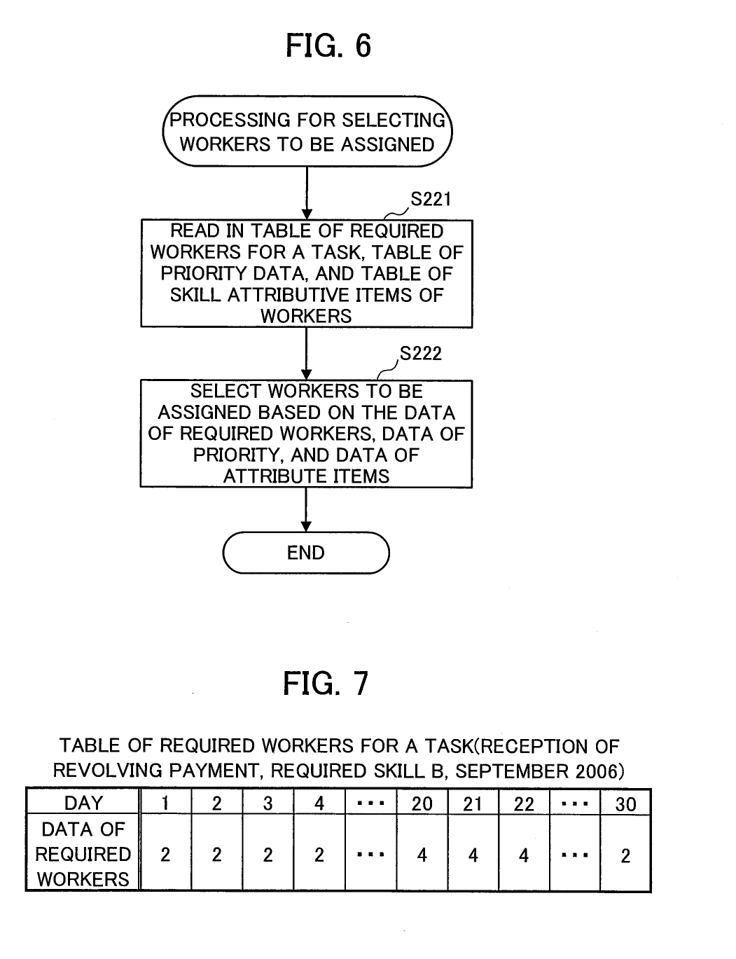

The exemplary description for performing the processing for selecting the workers to be assigned is described herein with reference to FIG. 6 which shows a flow chart of an exemplary embodiment of the method according to the present invention for performing such process that can be performed by the exemplary computer 10. For example, the controller 110, in Step S221, may read in a table of required workers for a task, a table of priority data, and a table of skill attributive items of workers. The exemplary computer 10 can store in the storage unit/arrangement 120 the table of priority data, the table of required workers for a task, and the table of skill attributive items of workers.

The table of required workers for a task (e.g., a reception of revolving payment, required skill B, September 2006) illustrated in FIG. 7 can include or store a preferred or required number of workers (e.g., data associated with the required workers) having a preferred and/or required skill per task. For example, the task of reception of revolving payment can prefer or require the skill named “B”, and may indicate that, on Sep. 20, 2006, 4 people are required.

Referring to the flow chart of FIG. 6, the controller 110, in Step S222, can select workers to be assigned based on the data of required workers, priority data, and data of attribute items. When processing of Step S222 completes, the controller 110 can finish the processing procedure for selecting the workers to be assigned.

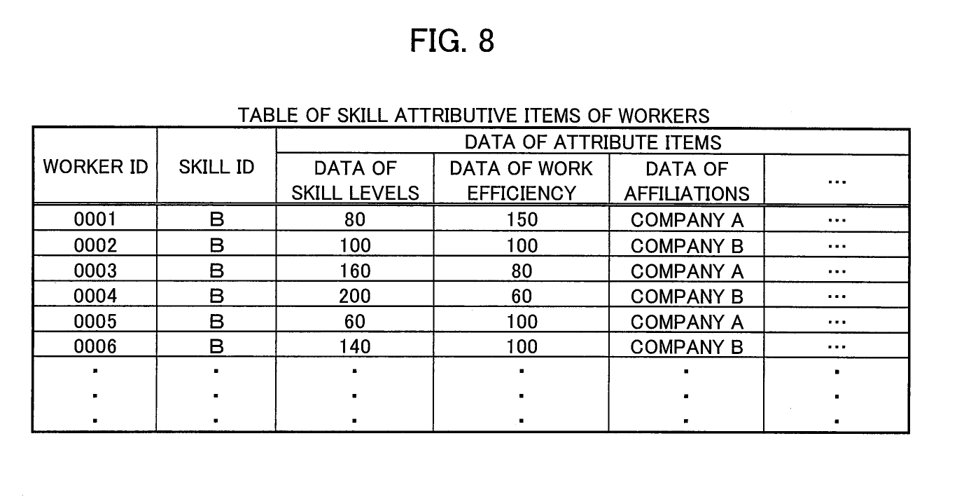

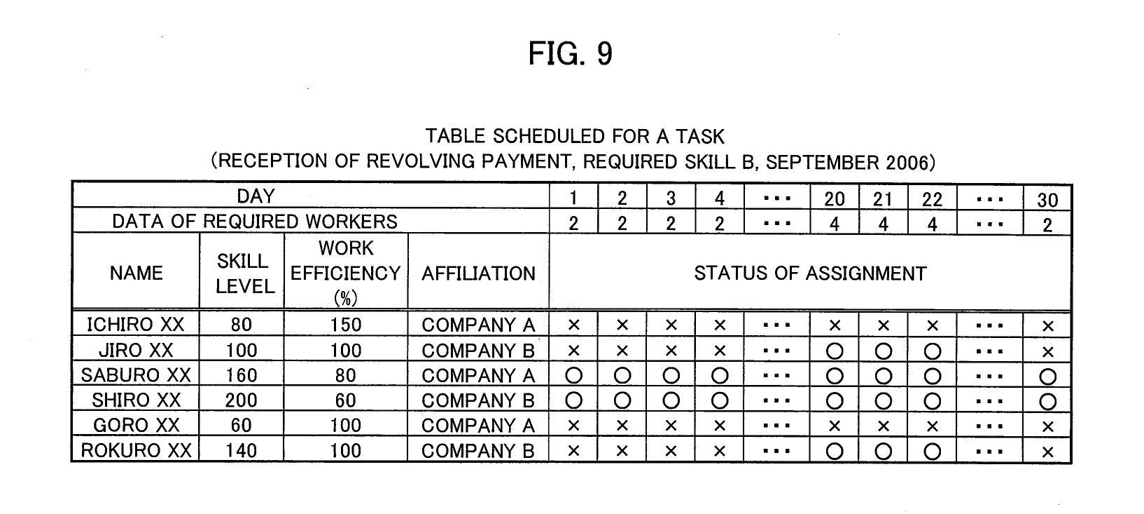

As an exemplary embodiment of the method for selecting workers, e.g., it is possible to use a known method using statistical techniques or AI (artificial intelligence). In addition, the controller 110 can select workers by creating an exemplary table scheduled for a task as shown in FIGS. 9, 11, 13 and 15, based on the data of required workers, data of priority, and the data of attribute items of the table of exemplary skill attributive items illustrated in FIGS. 8, 10, 12, and 14.

For example, the exemplary tables of skill attributive items of workers illustrated in FIGS. 8, 10, 12, and 14 can store the data of attribute items (e.g., skill level data, work efficiency data, affiliation data, and the like) associated with a skill possessed by each worker. As an example, as shown in FIG. 8, the worker of worker ID “0001” has skill “B”, and the values of the data of skill levels, the data of work efficiency, and the data of affiliates are “80”, “150”, and “Company A”, respectively.

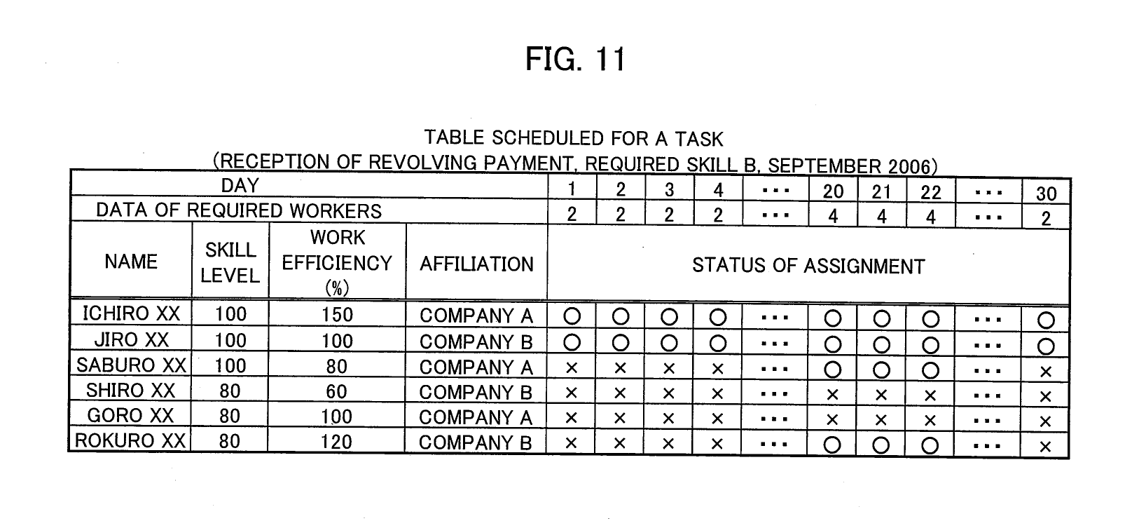

The exemplary tables scheduled for a task illustrated in FIGS. 11, 13 and 15 illustrate an exemplary status of selection (e.g., status of assignment) of workers including a worker ID having a required skill “B” for reception of revolving payment. For example, the full names and worker IDs can be associated by the table of correspondence between worker IDs and names (not illustrated), and “Ichiro XX”, “Jiro XX”, “Saburo XX”, “Shiro XX”, “Goro XX”, and “Rokuro XX” each correspond to worker IDs “0001”, “0002”, “0003”, “0004”, “0005”, and “0006”, respectively. Furthermore, if the exemplary status of selection is “O”, this indicates that a worker has been assigned on the corresponding day, and if “X”, this can indicate no assignment thereof.

As an initial matter, since an attribute item to which the priority data of “1” can be assigned is the data of skill levels, the controller 110 may select workers to be assigned in descending order of values of the data of skill levels. As illustrated in the exemplary table of FIG. 9, the required workers on the 2^{nd} column are 2 people, and the controller 110 can select “Shiro XX”, who has a highest value “200” of the data of skill levels illustrated in the exemplary table of FIG. 8, and “Saburo XX”, who has a second highest “160” thereof. Furthermore, required workers on the 20^{th} column are 4 people, and the controller 110, similarly, can select “Shiro XX”, “Saburo XX”, “Rokuro XX,” and “Jiro XX”.

Furthermore, since an attribute item with “2” of the priority data is the data of work efficiency, the controller 110, in a case of a plurality of workers who have identical values of the data of skill levels, may select the workers to be assigned in descending order of values of the data of work efficiency.

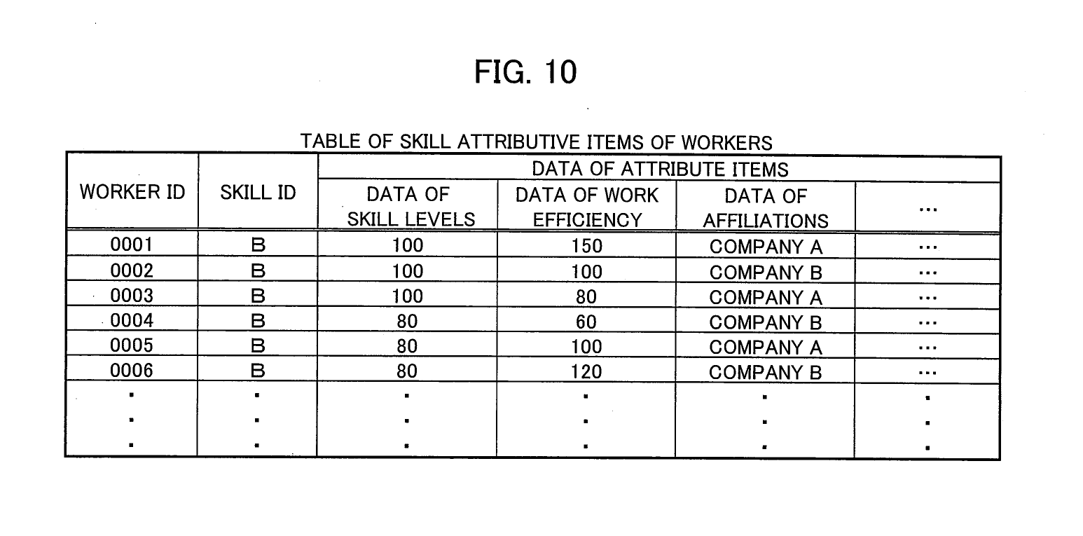

As illustrated in the exemplary table of FIG. 11, a preferred and/or required number of workers for the 2^{nd} column is 2 people, and the controller 110 can select from among “Ichiro XX”, “Jiro XX”, and “Saburo XX” having a highest value “100” of the data of skill levels illustrated in FIG. 10, “Ichiro XX”, who has a highest value “150” of the data of work efficiency, and “Jiro XX”, who has a second highest “100” thereof. Furthermore, the required workers on the 20^{th} column of the exemplary table of FIG. 11 are 4 people, and the controller 110, similarly, can select “Ichiro XX”, “Jiro XX”, “Saburo XX,” and “Rokuro XX”. In addition, since an attribute item with “3” of the data of priority is the data of affiliations, the controller 110, in a case of a plurality of workers who have identical values of the data of skill levels and the data of work efficiency, can select workers to be assigned based on a ratio of a number of workers registered at each affiliation.

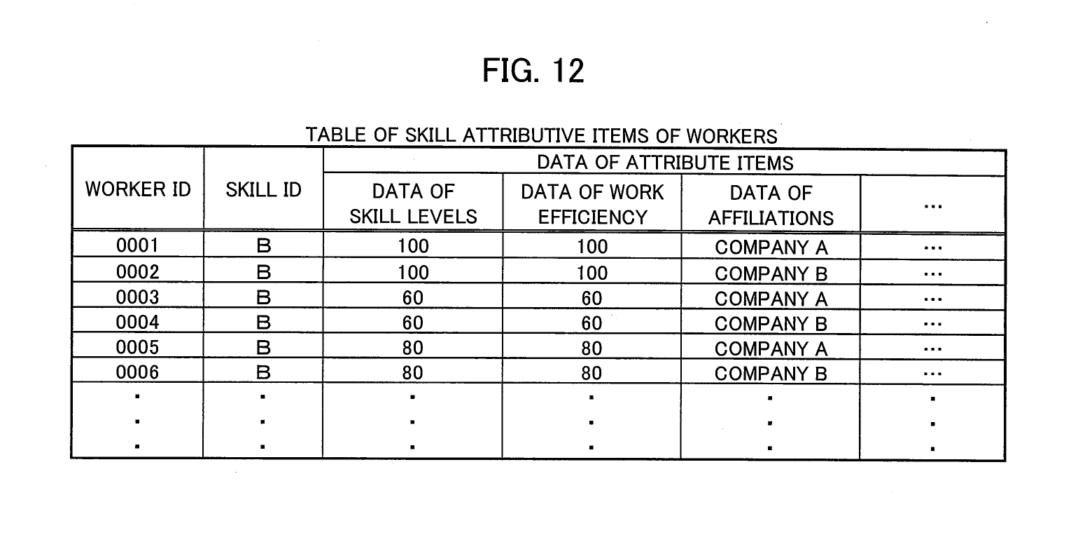

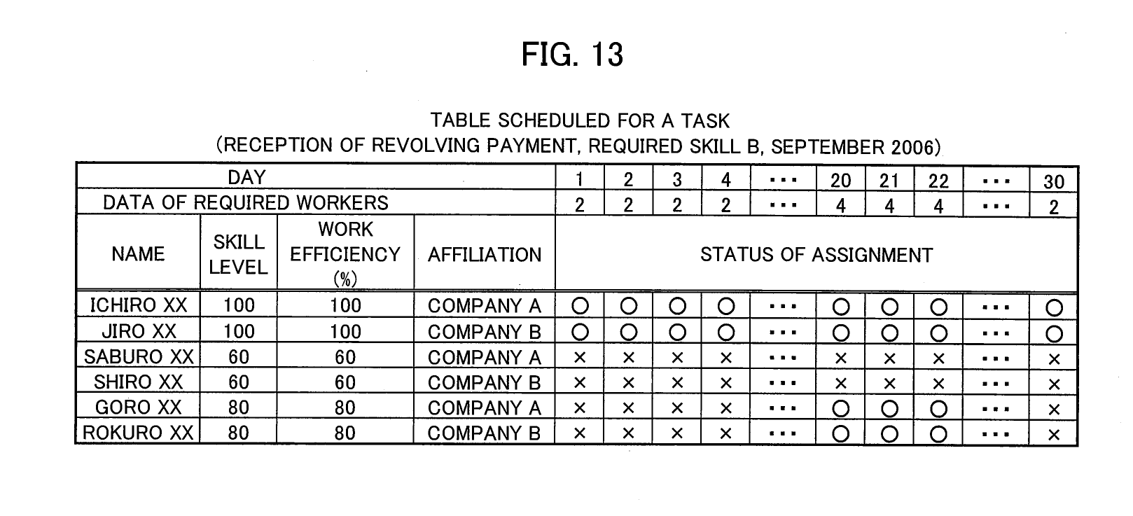

As illustrated in the exemplary table of FIG. 13, the required workers on the 2^{nd} column are 2 people, and values of the data of work efficiency of “Ichiro XX” and “Jiro XX” are each equal at “100”, who have a highest value “100” of the data of skill levels illustrated in the exemplary table of FIG. 12. Furthermore, since “Ichiro XX” and “Jiro XX” are each affiliated with “Company A” and “Company B”, respectively, a ratio of a number of workers registered with each affiliation is 1:1. Therefore, the controller 110 can select “Ichiro XX” and “Jiro XX”. Furthermore, the required workers on the 20^{th} column are 4 people, and the controller 110, similarly, can select “Ichiro XX”, “Jiro XX”, “Goro XX,” and “Rokuro XX”.

Furthermore, in a case where a plurality of workers has an identical value of the data of skill levels, an identical value of the data of work efficiency, and an identical value of the data of affiliations, the controller 110 can select a worker to be assigned by generating a random number.

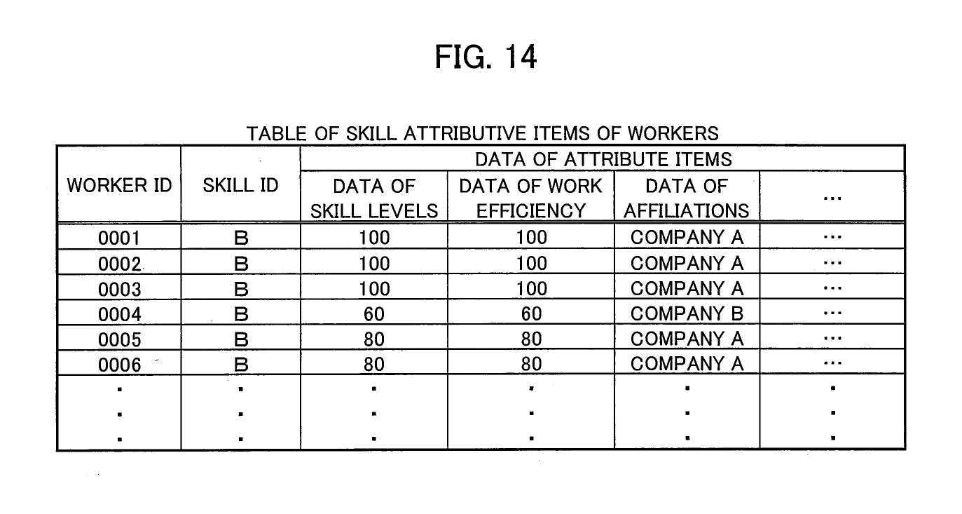

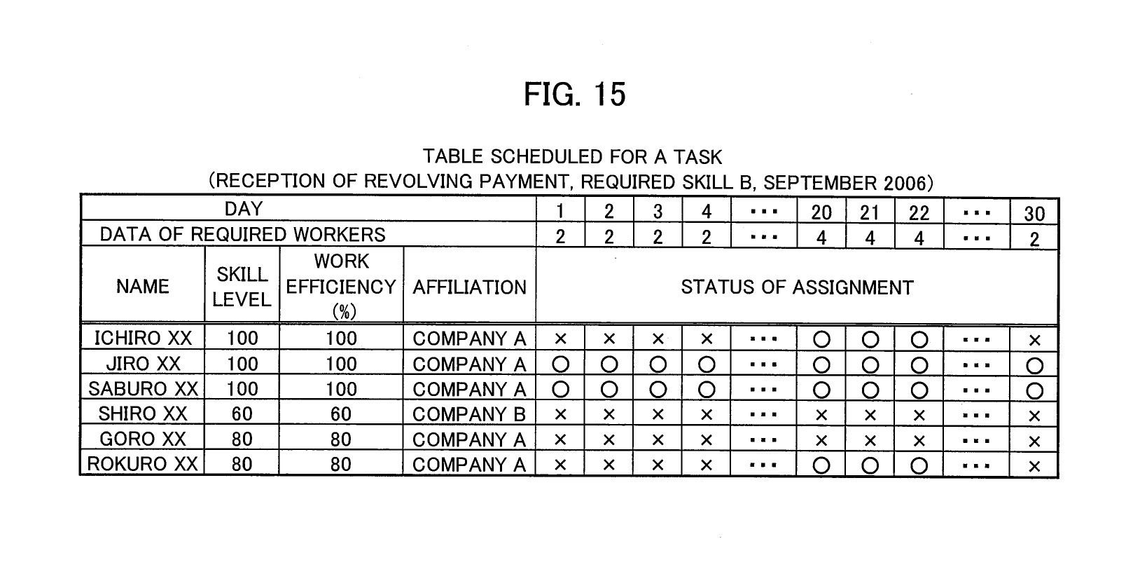

As illustrated in the exemplary table of FIG. 15, the required workers on the 2^{nd} column are 2 people, and values of the data of work efficiency of “Ichiro XX”, “Jiro XX”, and “Saburo XX”, are each equal at “100”, who have a highest value “100” of the data of skill levels illustrated in the exemplary table of FIG. 14. Furthermore, since “Ichiro XX”, “Jiro XX”, and “Saburo X” are each affiliated with “Company B” values of affiliation data are also equal. Therefore, the controller 110 can select “Jiro XX” and “Saburo XX” by generating random numbers. Furthermore, required workers on the 20^{th} are 4 people, and the controller 110, similarly, can select “Ichiro XX”, “Jiro XX”, “Saburo XX,” and “Rokuro XX”.

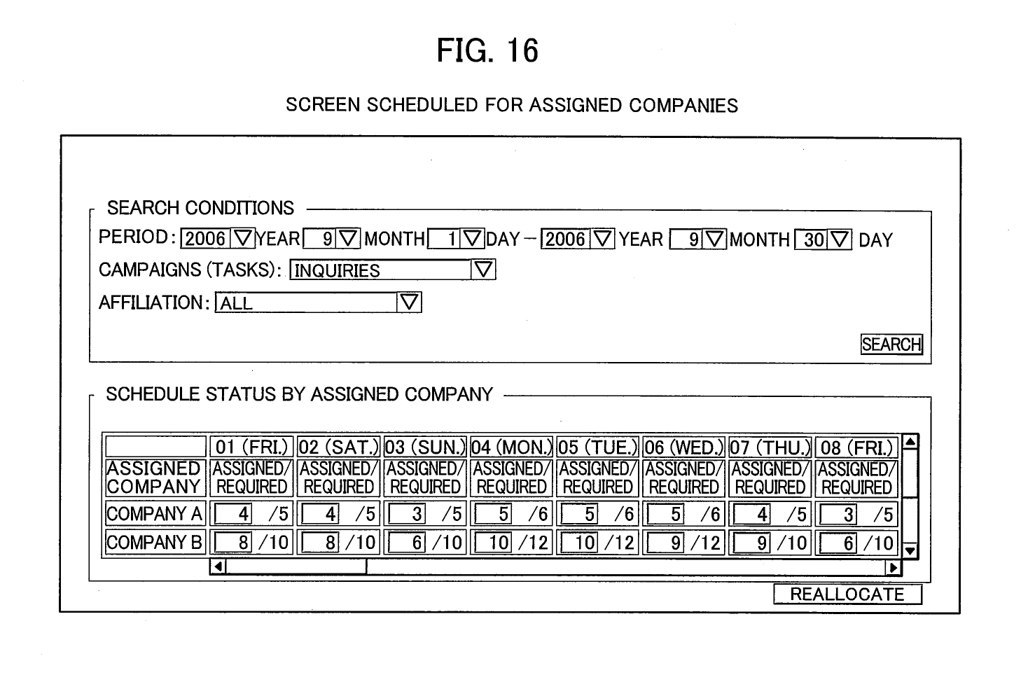

An exemplary screen or display scheduled for each assigned company illustrated in FIG. 16 can represent a schedule of one month of workers assigned by each assigned company. For example, the screen/display can indicate that a required number of people for the 3^{rd} column for Company A is 5 people and for Company B is 10 people. Furthermore, the screen/display can indicate that an assigned number of people for Company A is 3 people, and for Company B is 6 people. Additionally, a breakdown of the required workers can be by a ratio of a number of workers registered at each assigned company, and the controller 110 can allocate the required workers for each day.

In the exemplary embodiment, a ratio of the number of workers can be 1:2. Therefore, a total required number of workers for the 3^{rd} column being 15 people can be indicated. Furthermore, for workers to be assigned also, the controller 110 may allocate by a ratio of the number of workers registered. According to an availability situation of workers affiliated with each assigned company, allocation may not always be by a ratio of a number of the registered workers, but depending on circumstances, there may be cases in which a need may arise to change an allocation ratio.

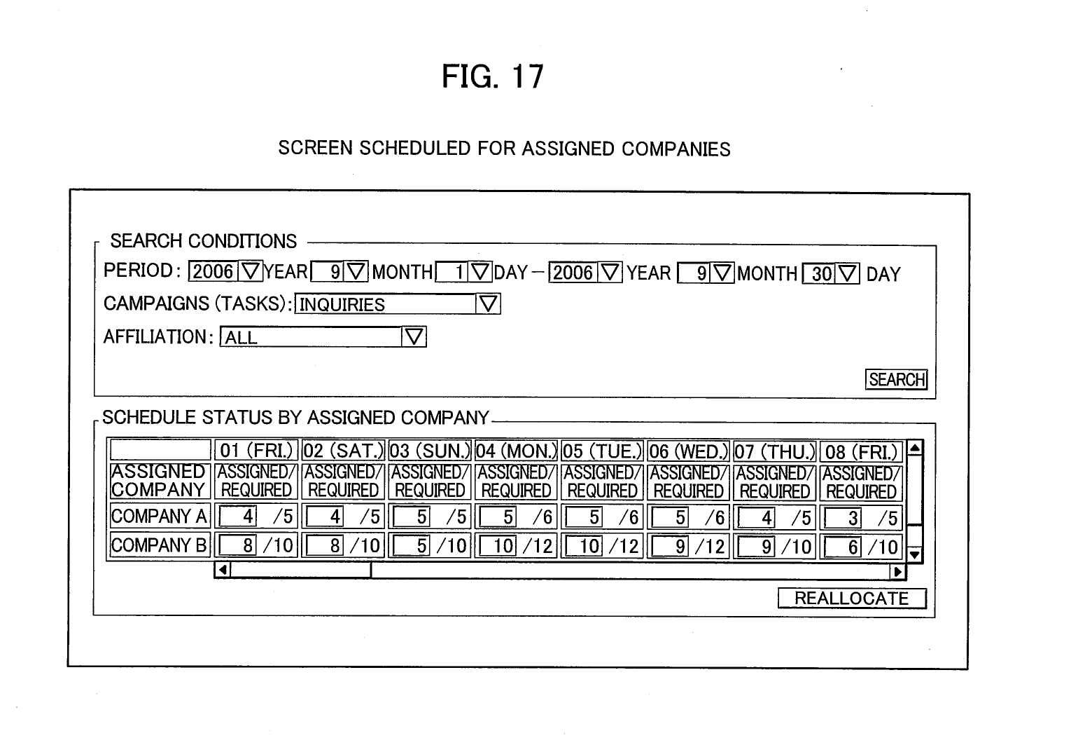

In the exemplary screen/display shown in FIG. 17, a number of assigned workers for the 3^{rd} column is been changed to 5 people for Company A, and to 5 people for Company B as well. When a reallocation execution button is pressed, the controller 110 can re-select workers to be assigned according to a changed ratio of workers assigned. For example, in the case of the 3^{rd} column, an allocation thereof can be performed at 1:1.

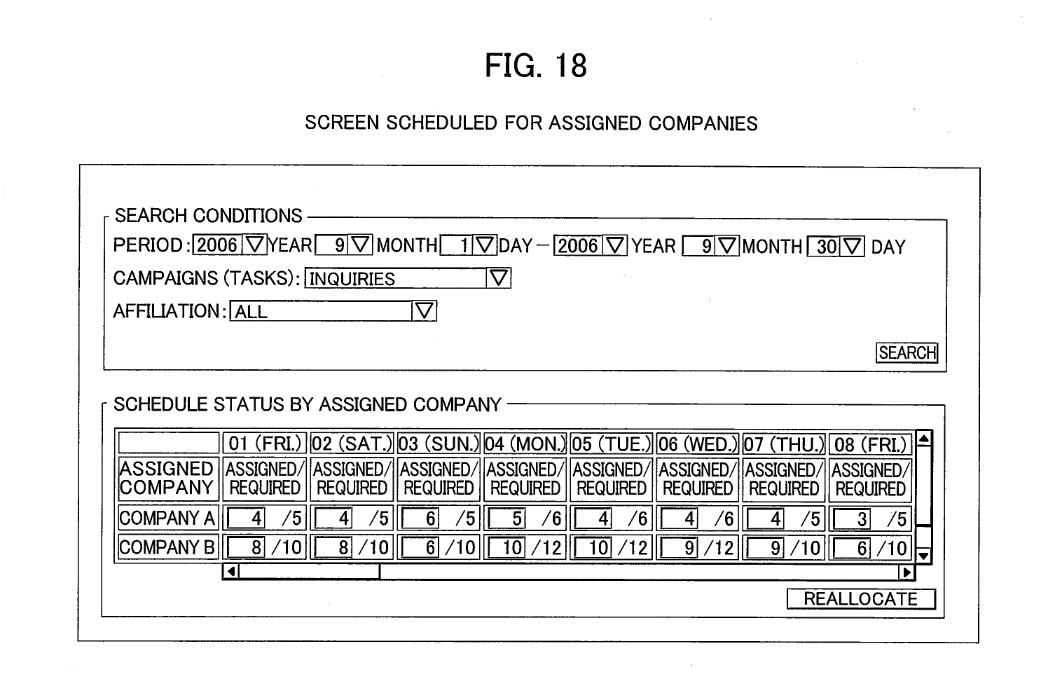

In the exemplary screen/display shown in FIG. 18, exemplary results of re-selecting workers to be assigned are illustrated. For example, in the case of the 3^{rd} column, the controller 110 can select so that Company A is 6 people, and Company B is also 6 people. Therefore, for the total required workers of 15 people for the 3^{rd} column, the total assigned workers are 12 people. However, since the controller 110 can adjustively select so that a ratio of 1:2 for the total month is approached, assigned workers for Company A regarding the 5^{th} column and the 6^{th} column are each reduced to 4 people each.

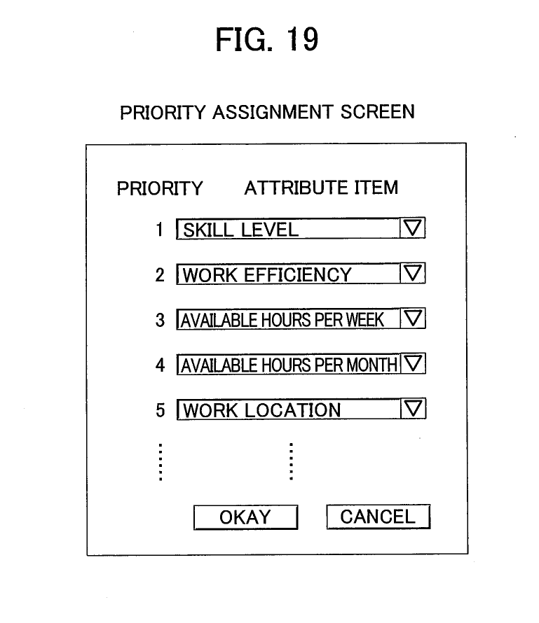

An exemplary screen/display for designating priority illustrated in FIG. 19 is not limited to the attribute items described above, but can also include a screen/display designating a priority including other attribute items as well. For example, as other attribute items, there are weekly available hours, monthly available hours, and the like.

Furthermore, for each priority, by designating an attribute item in a list box and pressing a confirmation button, it is possible to configure a priority for each attribute item.

In the exemplary embodiment, daily scheduling has been explained; however, monthly, hourly, weekly, yearly scheduling can also be generated and utilized acceptable.

Although embodiments of the present invention have been described, the exemplary embodiments of the present invention are not limited to the foregoing embodiments. Moreover, it should be understood that the advantages described in association with the embodiments are merely a listing of exemplary advantages, and that the advantages of the exemplary embodiments of the present invention are in no way restricted to those described in connection with the exemplary embodiments.

Indeed, the foregoing merely illustrates the exemplary principles of the exemplary embodiments of the present invention. Various modifications and alterations to the described embodiments will be apparent to those skilled in the art in view of the teachings herein. It will thus be appreciated that those skilled in the art will be able to devise numerous modification to the exemplary embodiments of the present invention which, although not explicitly shown or described herein, embody the principles of the exemplary embodiments of the present invention and are thus within the spirit and scope of such exemplary embodiments. All publications, applications and patents cited above are incorporated herein by reference in their entireties.

1-18. (canceled)

19. A method performed in an apparatus for automatically selecting a worker to be assigned for at least one task, wherein the apparatus comprises a computer including a controller, an input unit, a display unit and a storage unit; and
a server communicably connected with the computer,
the method comprising:
using the apparatus, storing in the storage unit:
(i) a first table of skill attributive items of a plurality of workers comprising, for each worker, a worker ID identifying a worker, a skill ID identifying a skill of the worker, and first data of attribute items associated with the worker ID and the skill ID, and
(ii) a second table of priority data comprising the first data and second data of priority, wherein the first data are configured to comprise third data of skill levels representing a degree of proficiency of the skill, fourth data of work efficiency determined based on an average handle time for one task and fifth data of companies representing, for each worker, a company by which the worker is employed, wherein the second data represents a priority of each of the first data for the purpose of selecting the worker to be assigned to the at least one task, and wherein data of past work record per skill is stored in the server and the controller is configured to receive the data of past work record per skill to generate the fourth data therewith;
causing the controller to receive an instruction to start entered by a user at the input unit;
causing the controller to assign a highest order to the priority of the third data;
causing the controller to automatically select an assigned worker to be assigned for each of the at least one task and prescribed periods based on sixth data of required workers representing a number of the plurality of workers having at least one required skill for each of the at least one task and the prescribed periods, and based on the second data, in order of descending values of the third data, wherein the sixth data is determined based on predicted values of a workload for each of the prescribed periods;
wherein, in the assigning procedure, the controller is configured to assign the highest order to the priority of the fourth data when values of the third data relating to a subset of the plurality of the workers are mutually equal,
wherein, in the selecting procedure, the controller is configured to select the assigned worker in a descending order of values of the fourth data,
wherein, in the assigning procedure, the controller is configured to assign the highest order to the priority of the fifth data when values of the third data relating to the subset of the plurality of the workers are mutually equal, and values of the fourth data relating to the subset of the plurality of the workers are mutually equal,
wherein, in the selecting procedure, the controller is configured to select the assigned worker based on a ratio of a number of the workers registered for each of the companies, wherein the controller is configured to display on the display unit a number of the plurality of workers for each of the companies of the plurality of workers selected based on a ratio of a number of the plurality of workers registered for each of the companies,
wherein the controller is configured to accept a modifying input of the number of the plurality of workers displayed with respect to a certain day requested by the user at the input unit, wherein, in the selecting procedure, the controller is configured to reassign the plurality of workers to be assigned for the certain day based on a ratio of the number of workers for which the modifying input has been accepted, and
wherein, in the selecting procedure, the controller is configured to reassign the plurality of workers to be assigned for other days than the certain day, such that a ratio of a number of the plurality of workers assigned over an entirety of a month resulting from reassigning is configured to be close to the ratio of the number of the workers registered for each of the companies, and
wherein each of the ascribed periods is configured to be divided into a plurality of time frames and the selecting an assigned worker is performed for each of the plurality of time frames.

20. The method according to claim 19, wherein, in the selecting procedure, the controller is configured to select the assigned worker by generating random numbers when values of the third data relating to the subset of the plurality of the workers are mutually equal, values of the fourth data relating to the subset of the plurality of the workers are mutually equal, and values of the fifth data relating to the subset of the plurality of the workers are mutually equal.

21. The method according to claim 19, further comprising, causing the controller to accept an input for configuring the second data via the input unit.

22. An apparatus for selecting workers to be assigned for at least one task, comprising:
a computer including a controller, an input unit, a display unit and a storage unit; and
a server communicably connected with the computer,
wherein the storage unit is configured to store (i) a first table of skill attributive items of a plurality of workers comprising, for each worker, at least a worker ID identifying a worker, a skill ID identifying a skill of the worker, and first data of attribute items associated with the worker ID and the skill ID, and (ii) a second table of priority data comprising the first data and second data of priority,
wherein the first data is configured to comprise third data of skill levels representing a degree of proficiency of the skill, fourth data of work efficiency determined based on an average handle time for one task and fifth data of companies representing a company by which each worker is employed, wherein the second data represents a priority of each of the first data for the purpose of selecting the worker to be assigned to the at least one task, and wherein data of past work record per skill is stored in the server and the controller is configured to receive the data of past work record per skill to generate the fourth data therewith,
wherein the controller is further configured to:
(a) cause the controller to receive an instruction to start entered by a user at the input unit;
(b) assign a highest order to the priority of the third data;
(c) select an assigned worker to be assigned for each of the tasks and prescribed periods, based on sixth data of required workers representing a number of workers having a required skill for each of the at least one task and the prescribed periods, and the second data, in order of descending values of the third data, the sixth data being determined from predicted values of workload for each prescribed periods;
wherein, in the assigning procedure (b), the controller is configured to assign the highest order to the priority of the fourth data when values of the third data relating to a subset of the plurality of the workers are mutually equal,
wherein, in the selecting procedure (c), the controller is configured to select the assigned worker in order of descending values of the fourth data,
wherein, in the assigning procedure (b), the controller is configured to assign the highest order to the priority of the fifth data when values of the third data relating to the subset of the plurality of the workers are mutually equal, and values of the fourth data relating to the subset of the plurality of the workers are mutually equal,
wherein, in the selecting procedure (c), the controller is configured to select the assigned worker based on a ratio of a number of the workers registered for each of the companies,
wherein the controller is configured to display on the display unit a number of the plurality of workers for each of the companies of the plurality of workers selected based on a ratio of a number of the plurality of workers registered for each of the companies,
wherein the controller is configured to accept a modifying input of the number of the plurality of workers displayed with respect to a certain day requested by the user at the input unit,
wherein, in the selecting procedure (c), the controller is configured to reassign the plurality of workers to be assigned for the certain day based on a ratio of the number of workers for which the modifying input has been accepted, and
wherein, in the selecting procedure (c), the controller is configured to reassign the plurality of workers to be assigned for other days than the certain day, such that a ratio of a number of the plurality of workers assigned over an entirety of a month resulting from reassigning is configured to be close to the ratio of the number of the workers registered for each of the companies, and
wherein each of the ascribed periods is configured to be divided into a plurality of time frames and the selecting an assigned worker in (c) is performed for each of the plurality of time frames.

23. The apparatus according to claim 22, wherein, in the selecting procedure (c), the controller is configured to select the assigned worker by generating random numbers when values of the third data relating to the subset of the plurality of the workers are mutually equal, values of the fourth data relating to the subset of the plurality of the workers are mutually equal, and values of the fifth data relating to the subset of the plurality of the workers are mutually equal.

24. The apparatus according to claim 22, wherein the controller is configured to accept an input for configuring the second data entered by the user at the input unit.

25. A non-transitory computer-accessible medium which includes software thereon for selecting workers to be assigned for at least one task, wherein the software is executed in an apparatus including a computer including a controller, an input unit, a display unit and a storage unit; and
a server communicably connected with the computer, and when the software is executed in the apparatus, the software is configured to cause the apparatus to execute procedures comprising:
storing in the storage unit (i) a first table of skill attributive items of a plurality of workers comprising, for each worker, at least a worker ID identifying a worker, a skill ID identifying a skill of the worker, and first data of attribute items associated with the worker ID and the skill ID, and (ii) a second table of priority data comprising the first data and second data of priority, wherein the first data is configured to comprise third data of skill levels representing a degree of proficiency of the skill, fourth data of work efficiency determined based on an average handle time for one task and fifth data of companies representing a company by which each worker is employed, wherein the second data represents a priority of each of the first data for the purpose of selecting an assigned worker to be assigned to the at least one task and wherein data of past work record per skill is stored in the server and the controller is configured to receive the data of past work record per skill to generate the fourth data therewith,
causing the controller to receive an instruction to start entered by a user at the input unit;
assigning, via the controller, a highest order to the priority of the third data; and
selecting, via the controller, at least one assigned worker to be assigned for each of the tasks and prescribed periods, based on sixth data of required workers representing a number of the plurality of workers having a required skill for each of the at least one task and the prescribed periods, and the second data, in order of descending values of the third data, the sixth data being determined from predicted values of workload for each prescribed periods,
wherein the software, when executed by the apparatus, further configures the controller, in the assigning procedure, to assign the highest order to the priority of the fourth data when values of the third data relating to the subset of the plurality of the workers are mutually equal,
wherein the software, when executed by the apparatus, further configures the controller, in the selecting procedure, to select the at least one assigned worker in order of descending values of the fourth data,
wherein the software, when executed by the apparatus, further configures the controller, in the assigning procedure, to assign the highest order to the priority of the fifth data when values of the third data relating to the subset of the plurality of the workers are mutually equal, and values of the fourth data relating to the subset of the plurality of the workers are mutually equal,
wherein the software, when executed by the apparatus, further configures the controller, in the selecting procedure, to select the at least one assigned worker based on a ratio of a number of the workers registered for each of the companies,
wherein the software, when executed by the apparatus, further configures the controller to display on the display unit a number of the plurality of workers for each of the companies of the plurality of workers selected based on a ratio of a number of the plurality of workers registered for each of the companies,
wherein the software, when executed by the apparatus, further configures the controller to accept a modifying input of the number of the plurality of workers displayed with respect to a certain day requested by the user at the input unit,
wherein the software, when executed by the apparatus, further configures, in the selecting procedure, the controller to reassign the plurality of workers to be assigned for the certain day based on a ratio of the number of workers for which the modifying input has been accepted, wherein the software, when executed by the apparatus, further configures, in the selecting procedure, the controller to reassign the plurality of workers to be assigned for other days than the certain day, such that a ratio of a number of the plurality of workers assigned over an entirety of a month resulting from reassigning is configured to be close to the ratio of the number of the workers registered for each of the companies, and
wherein each of the ascribed periods is configured to be divided into a plurality of time frames and the selecting an assigned worker is performed for each of the plurality of time frames.

26. The computer-accessible medium according to claim 25, wherein the software, when executed by the apparatus, further configures the controller, in the selecting procedure, to select the at least one assigned workers by generating random numbers when values of the third data relating to the subset of the plurality of the workers are mutually equal, values of the fourth data relating to the subset of the plurality of the workers are mutually equal, and values of the fifth data relating to the subset of the plurality of the workers are mutually equal.

27. The computer-accessible medium according to claim 25, wherein the software, when executed by the apparatus, further configures the controller to accept an input for configuring the second data entered by the user at the input unit.
